(19) United States
(12) Patent Application Publication
(10) Pub. No.: US 2024/0056959 A1
(43) Pub. Date: Feb. 15, 2024

(54) METHODS AND SYSTEM FOR DETERMINING LAST PLMN FOR MINT

(71) Applicant: Samsung Electronics Co., Ltd., Suwon-si (KR)

(72) Inventors: Aman AGARWAL, Bangalore (IN); Kailash Kumar JHA, Bangalore (IN); Lalith KUMAR, Bangalore (IN); Mahmoud WATFA, Staines (GB)

(21) Appl. No.: 18/448,069

(22) Filed: Aug. 10, 2023

(30) Foreign Application Priority Data
Aug. 10, 2022 (IN) 202241045800
Jul. 11, 2023 (IN) 202241045800

(51) Int. Cl. H04W 48/18; H04W 8/06; H04W 24/04

(52) U.S. Cl. CPC H04W 48/18; H04W 8/06; H04W 24/04

(57) ABSTRACT

In a scenario, wherein the UE is registered for disaster roaming services with the VPLMN, in a disaster scenario, the UE can periodically attempt to obtain service on an allowable PLMN. The UE can make a first attempt to obtain service on the allowable PLMN, after a T1 duration and at most a T duration on selecting the VPLMN.

The disclosure relates to a 5G or 6G communication system for supporting a higher data transmission rate.

### CROSS REFERENCE TO RELATED APPLICATIONS

This application is based on and derives the benefit of Indian Provisional Application No. 202241045800 filed on Aug. 10, 2022, and Indian Non-Provisional Application No. 202241045800 filed on Jul. 11, 2023, the contents of which are incorporated herein by reference.

### BACKGROUND

### 1. Field

Embodiments disclosed herein relate to wireless communication networks, and more particularly to methods and systems for determining last Public Land Mobile Network (PLMN) for Minimization of Service Interruption (MINT) in wireless communication networks.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The principal object of the embodiments herein is to disclose methods and systems for determining a last Public Land Mobile Network (PLMN) for Minimization of Service Interruption (MINT) in wireless communication networks.

The purpose of MINT is to minimize interruption of service to users during disaster situations. In disaster situations, the device or the UE registers to a rescue PLMN which is a forbidden PLMN to get disaster roaming service. The disaster roaming services might have differential pricing (for ex-Disaster roaming may have higher charges in comparison to normal services) from both the UE and the Operator's perspective and both the UE or/and the Operator would prefer normal services received from a non forbidden PLMN i.e. allowable PLMN.

Therefore, when the UE is registered to a FPLMN, the UE would want to scan/search and register to an allowable PLMN which can provide normal service to the UE. For this, the UE shall periodically attempt to obtain service on an allowable PLMN after timer T. Also, the UE shall make the following attempts if the UE is registered for disaster roaming services at time T expiry after the last attempt.

However, it is not defined as to when the UE shall make the first periodic attempt to obtain service on an allowable PLMN.

The technical subjects pursued in the disclosure may not be limited to the above mentioned technical subjects, and other technical subjects which are not mentioned may be clearly understood, through the following descriptions, by those skilled in the art to which the disclosure pertains.

The proposed solution defines a method as to when the UE shall make the first attempt to scan for an allowable PLMN while registered on a FPLMN/any PLMN for disaster roaming services.

The present disclosure provides an effective and efficient method for determining a last Public Land Mobile Network (PLMN) for Minimization of Service Interruption (MINT) in wireless communication networks.

Accordingly, the embodiments herein provide a method for a User Equipment (UE) to attempt to obtain service on an allowable Public Land Mobile Network (PLMN) in a network. The method comprises making a first attempt, by the UE, to obtain service on an allowable PLMN, after a period of at least T1 duration and at most T duration on selecting a Visited PLMN (VPLMN) for receiving disaster roaming service.

Accordingly, the embodiments herein provide a User Equipment (UE) (501) configured for making a first attempt to obtain service on an allowable PLMN, after a period of at least T1 duration and at most T duration on selecting a VPLMN for receiving disaster roaming service.

Advantageous effects obtainable from the disclosure may not be limited to the above mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the drawings, in which:

FIGS. 1-4 illustrate scenarios, wherein a UE attempts to obtain service on an allowable PLMN in a disaster scenario;

FIG. 5 illustrates a network comprising at least one UE connected to at least one PLMN, according to embodiments as disclosed herein;

FIG. 6 illustrates a flowchart depicting the process of a UE attempting to select an allowable PLMN, when connected to a VPLMN, according to embodiments as disclosed herein;

and

FIG. 7 illustrates various hardware components of the UE 501, according to embodiments as disclosed herein.

### DETAILED DESCRIPTION

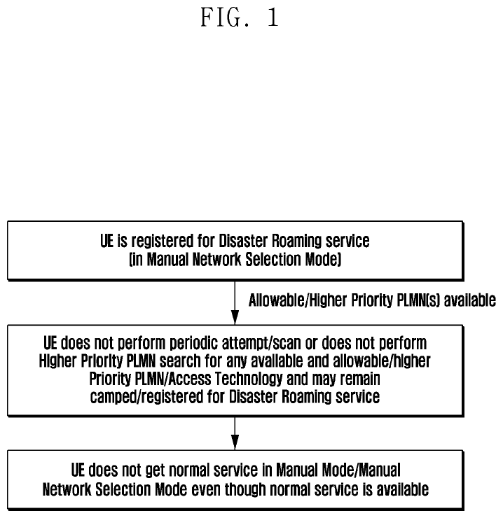

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Accordingly, the embodiments herein provide a method for a User Equipment (UE) to attempt to obtain service on an allowable Public Land Mobile Network (PLMN) in a network. The method comprises making a first attempt, by the UE, to obtain service on an allowable PLMN, after a period of at least T1 duration and at most T duration on selecting a Visited PLMN (VPLMN) for receiving disaster roaming service.

Accordingly, the embodiments herein provide a User Equipment (UE) (501) configured for making a first attempt to obtain service on an allowable PLMN, after a period of at least T1 duration and at most T duration on selecting a Visited PLMN (VPLMN) for receiving disaster roaming service.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

The purpose of Minimization of Service Interruption (MINT) is to minimize interruption of service to users, when the network to which these users are subscribed cannot provide service due to a disaster such as a fire, by enabling the users to obtain service on other networks, while at the same time protecting those other networks from congestion.

Consider that Public Land Mobile Network (PLMN) D or PLMN-D is subject to disaster (i.e., PLMN-D is the PLMN with disaster condition) and PLMN A or PLMN-A is alive and not subject to disaster. PLMN-A may provide disaster roaming service to the users of the PLMN-D (i.e., to the Disaster Inbound roamers of the PLMN-D)

If the UE or the Mobile Station (MS) is in a Visited PLMN (VPLMN) and the UE is registered for disaster roaming services, the UE shall periodically attempt to obtain service on an allowable PLMN of the same country as the current serving PLMN.

If the UE is registered for disaster roaming services, timer T is either in the range 30 minutes to 40 hours in 30 minute steps, or it indicates that no periodic attempts shall be made. If no value for T is stored in the SIM, a default value of 60 minutes is used for T. If the UE is configured with the MinimumPeriodicSearchTimer, the UE shall not use a value for T that is less than the MinimumPeriodicSearchTimer. If the value stored in the SIM, or the default value for T (when no value is stored in the SIM), is less than the MinimumPeriodicSearchTimer, then T shall be set to the MinimumPeriodicSearchTimer. The UE does not stop timer T when it activates power saving mode (PSM) or mobile initiated connection only mode (MICO).

The attempts to obtain service on an allowable PLMN shall be as specified below:
a) The periodic attempts shall only be performed in automatic mode when the UE is registered for disaster roaming services and does not have a Packet Data Unit (PDU) session for emergency services;
b) The UE shall make the following attempts if the UE is registered for disaster roaming services at time T after the last attempt;
c) The periodic attempts shall only be performed by the UE while in idle mode or 5GMM-CONNECTED mode with Radio Resource Control (RRC) inactive indication;
d) The periodic attempts may be postponed:
   while the UE is in power saving mode (PSM);
   while the UE is receiving evolved Multimedia Broadcast Multicast Service (eMBMS) transport service in idle mode;
   till the next extended Discontinuous Reception (eDRX) occasion while the UE is configured with eDRX;
   while the UE is in relaxed monitoring; and
   while the UE is in Mobile Initiated Connection Only mode (MICO); and
e) The UE shall limit its attempts to access allowable PLMN/access technology combinations of the same country as the current serving VPLMN, as defined below.

EXCEPTION: If the UE is in a VPLMN through satellite NG-RAN access with a shared Mobile Country Code (MCC), the UE may attempt to access higher priority PLMN/access technology combinations irrespective of their MCC values.

EXCEPTION: If the UE is in a VPLMN through non-satellite access, the UE may attempt to access higher priority PLMNs with a shared MCC with satellite NG-RAN access technology.

Note: While a UE is roaming on a VPLMN, the VPLMN and a PLMN are of the same country only if their MCC values identify the same country.

As illustrated in FIG. 1, the periodic attempts shall only be performed in automatic mode when the UE is registered for disaster roaming services and does not have a PDU session for emergency services. However, the UE may be registered for disaster roaming services in Manual Network Selection Mode. It is always advisable for the UE or the UE to receive normal services over disaster roaming services. Moreover, the disaster roaming services might have differential pricing (for example, Disaster roaming may have higher charges in comparison to normal services) from both UE and Operator's perspective and the UE or/and the Operator would want to prefer normal services over disaster roaming services. However, periodic attempts shall only be performed by the UE in automatic mode and periodic attempts to obtain service on an allowable PLMN shall not be performed by the UE in the Manual mode or Manual Network Selection mode. Currently, there is no way defined for the UE to perform periodic attempts to obtain service on an allowable PLMN in Manual Mode or Manual Network Selection mode and a method needs to be defined. For example, the UE is registered for disaster roaming service on a PLMN-A of Country-X at time T during Manual Network Selection Mode. After some time, for example Time T+T0, PLMN-B or any allowable PLMN of the UE or any higher priority PLMN of the UE of Country-X is available. PLMN-B is allowable for the UE. However, the UE is not allowed to make periodic attempts for higher priority PLMN search in Manual Mode. Even though normal services were available for the UE from Time T+T0, the UE might still be camped on PLMN-A for disaster roaming service. Therefore, a method needs to be defined for the UE to make periodic attempts for higher priority PLMN search when camped in Manual Mode.

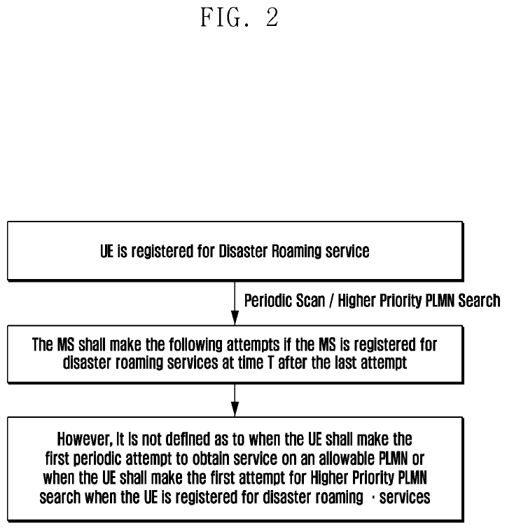

As illustrated in FIG. 2, the UE shall make the following attempts if the UE is registered for disaster roaming services at time T after the last attempt. However, it is not defined as to when the UE shall make the first periodic attempt to obtain service on an allowable PLMN or when the UE shall make the first attempt for Higher Priority PLMN search when the UE is registered for disaster roaming services. If the UE makes the first periodic attempt just after registering on a Visited PLMN (VPLMN) for disaster roaming service, the UE may not be able to find any higher priority PLMN(s) as the disaster condition might still be ongoing and the current serving PLMN may be the Highest or most priority PLMN or the only PLMN providing service (either disaster roaming service or normal service or any service) to the UE. This first periodic attempt, just after registering for disaster roaming service, may un-necessarily lead to high power consumption in the UE. Similarly, if the UE makes the first periodic attempt, to obtain service on an allowable PLMN or to attempt for Higher Priority PLMN search, after a long period of time after registering on a Visited PLMN (VPLMN) for disaster roaming service, the UE might still be camped on the current serving PLMN for disaster roaming service even though the UE might be able to get normal service from some other PLMN(s) between the time that the UE registered for disaster roaming service and the time when the UE made the first periodic attempt. It is beneficial for the UE as well as the operator if the UE is registered for normal services rather than disaster roaming services. Currently, there is no method defined as to when shall the UE make the first periodic attempt and a method needs to be defined. For example, the UE is initially registered for disaster roaming service on a PLMN-A of Country-X at time T. After Time T+T0, PLMN-B or any allowable PLMN of the UE or any higher priority PLMN of the UE of Country-X is available. PLMN-B is allowable for the UE. However, it is not defined as to when the UE shall make the first periodic attempt for higher priority PLMN search when the UE is registered for Disaster roaming services. If the UE makes first attempt too early (i.e., between T and T+T0), the UE might lose battery and it would lead to higher power consumption. If the UE makes first attempt too late (i.e., after few hours of T+T0), the UE might not get normal services quickly even though normal services were available from Time T+T0. Therefore, a proper timer needs to be defined as to when shall UE make the first attempt when the UE is registered for Disaster roaming services.

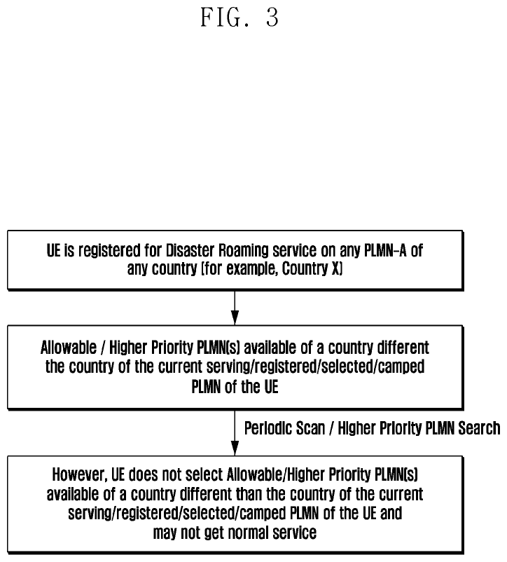

As illustrated in FIG. 3, the UE shall limit its attempts to access allowable/Higher Priority PLMN/access technology combinations of the same country as the current serving PLMN or VPLMN (with an exception in the case of satellite NG-RAN access technology). However, there might be cases where the UE may find an allowable/Higher Priority PLMN of a country different than the country of the current serving/registered/selected/camped PLMN of the UE. This may be due to the UE's mobility to the border area (where the UE may find allowable PLMN(s) of countries other than the current serving PLMN) or may be when UE finds allowable PLMN(s) with a shared MCC with or without satellite NG-RAN access technology. Currently, there is no method defined for the UE to select allowable/Higher Priority PLMN/access technology combinations of the countries other than the current serving PLMN and a method needs to be defined. For example, the UE is initially registered for disaster roaming service on a PLMN-A of Country-X. The UE is in an area where normal services are available through PLMN-B or any allowable PLMN of the UE or any higher priority PLMN of the UE of Country-Y and PLMN-B is allowable for the UE. The UE shall not attempt registration on PLMN-B for normal services as Country-Y of PLMN B is not the same as the country (Country-X) of the current serving PLMN (PLMN-A). Thus, the UE is not getting normal services even though normal services are available.

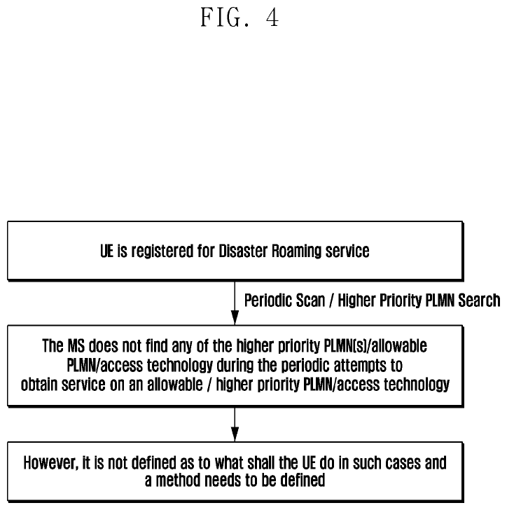

As illustrated in FIG. 4, it is not defined as to what the UE shall do if any of the higher priority PLMN(s)/allowable PLMN/access technology is not found during the periodic attempts to obtain service on an allowable/higher priority PLMN/access technology. Currently, there is no UE behaviour defined in such cases and a method needs to be defined.

Hence, there is a need in the art for solutions which will overcome the above mentioned drawbacks, among others.

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

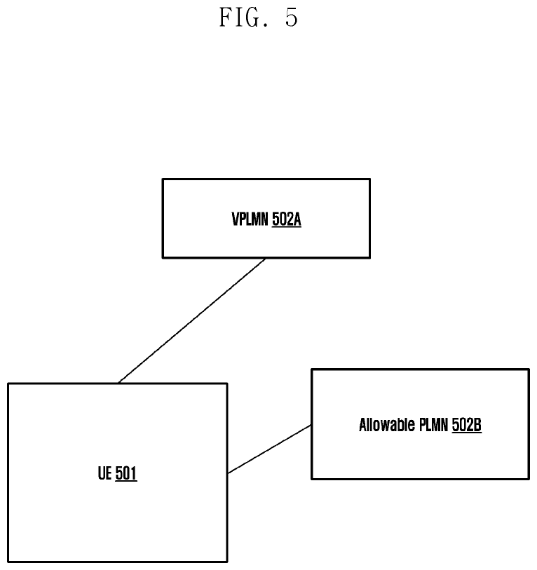

The embodiments herein achieve methods and systems for determining last Public Land Mobile Network (PLMN) for Minimization of Service Interruption (MINT) in wireless communication networks. Referring now to the drawings, and more particularly to FIGS. 5 through 7, where similar reference characters denote corresponding features consistently throughout the figures, there are shown example embodiments.

The following abbreviations and definitions have been referred to herein:
4G-GUTI: 4G-Globally Unique Temporary Identifier
5GCN5G Core Network
5G-GUTI: 5G-Globally Unique Temporary Identifier
5GMM: 5GS Mobility Management
5G-RG: 5G Residential Gateway
5G-BRG: 5G Broadband Residential Gateway
5G-CRG: 5G Cable Residential Gateway
5GS: 5G System
5GSM: 5GS Session Management
5G-S-TMSI: 5G S-Temporary Mobile Subscription Identifier
5G-TMSI: 5G Temporary Mobile Subscription Identifier
5QI: 5G QoS Identifier
ACS: Auto-Configuration Server
AKA: Authentication and Key Agreement
AKMA: Authentication and Key Management for Applications
A-KID: AKMA Key Identifier
A-TID: AKMA Temporary Identifier
AMBR: Aggregate Maximum Bit Rate
AMF: Access and Mobility Management Function
APN: Access Point Name
ATSSS: Access Traffic Steering, Switching and Splitting
AUSF: Authentication Server Function
CAG: Closed access group
CHAP: Challenge Handshake Authentication Protocol
SUCI: Subscription Concealed Identifier
PLMN: Public Land Mobile Network
MS: Mobile Station (embodiments herein make no distinction between MS and UE).
UE: User Equipment
ME: Mobile Equipment
USIM: Universal Subscriber Identity Module
UDM: Unified Data Management Function
SIM: Subscriber Identity Module
VPLMN: Visited PLMN
HPLMN: Home PLMN
MINT: Minimization of service interruption
3GPP: Third Generation Partnership Project
MICO: Mobile Initiated Communication Only
PSM: Power Saving Mode
MCC: Mobile Country Code
NG-RAN: Next Generation Radio Access Network
DRX: Discontinuous Reception
eDRX: Extended Discontinuous Reception
eMBMS: evolved Multimedia Broadcast Multicast Service
FPLMN: Forbidden Public Land Mobile Network
ME: Mobile Equipment
MS: Mobile Station. The present document makes no distinction between MS and UE.

Allowable PLMN: In the case of a UE operating in UE operation mode A or B, this is a PLMN which is not in the list of “forbidden PLMNs” in the MS. In the case of a UE operating in UE operation mode C or a UE not supporting A/Gb mode and not supporting Iu mode, this is a PLMN which is not in the list of “forbidden PLMNs” and not in the list of “forbidden PLMNs for GPRS service” in the MS.

Available PLMN: For GERAN A/Gb mode see 3GPP TS 43.022. For UTRAN see 3GPP TS 25.304. For E-UTRAN see 3GPP TS 36.304. For NG-RAN see 3GPP TS 36.304 and 3GPP TS 38.304. For cdma2000® 1×RTT and cdma2000® HRPD see 3GPP2 C.S0016. PLMN(s) in the given area which is/are broadcasting capability to provide wireless communication services to the UE.

Camped on a cell: The UE (ME if there is no SIM) has completed the cell selection/reselection process and has chosen a cell from which it plans to receive all available services. Note that the services may be limited, and that the PLMN or the SNPN may not be aware of the existence of the UE (ME) within the chosen cell.

EHPLMN: Any of the PLMN entries contained in the Equivalent HPLMN list.

Visited PLMN (VPLMN): This is a PLMN different from the HPLMN (if the EHPLMN list is not present or is empty) or different from an EHPLMN (if the EHPLMN list is present).

Equivalent HPLMN list: To allow provision for multiple HPLMN codes, PLMN codes that are present within this list shall replace the HPLMN code derived from the International Mobile Subscriber Identity (IMSI) for PLMN selection purposes. This list is stored on the USIM and is known as the EHPLMN list. The EHPLMN list may also contain the HPLMN code derived from the IMSL If the HPLMN code derived from the IMSI is not present in the EHPLMN list, then it shall be treated as a Visited PLMN for PLMN selection purposes.

Home PLMN: This is a PLMN where the MCC and Mobile Network Code (MNC) of the PLMN identity match the MCC and MNC of the IMSI.

Registered PLMN (RPLMN): This is the PLMN on which certain Location Registration (LR) outcomes have occurred. In a shared network the RPLMN is the PLMN defined by the PLMN identity of the Core Network (CN) operator that has accepted the LR.

Registration: This is the process of camping on a cell of the PLMN or the Standalone Non-Public Network (SNPN) and doing any necessary LRs.

UPLMN: PLMN/access technology combination in the “User Controlled PLMN Selector with Access Technology” data file in the SIM (in priority order).

OPLMN: PLMN/access technology combination in the “Operator Controlled PLMN Selector with Access Technology” data file in the SIM (in priority order) or stored in the ME (in priority order).

Disaster Condition: This is the condition that a government decides when to initiate and terminate, e.g., a natural disaster. When this condition applies, users may have the opportunity to mitigate service interruptions and failures.

Disaster Inbound Roamer: A user that (a) cannot get service from the PLMN it would normally be served by, due to failure of service during a Disaster Condition, and (b) is able to register with other PLMNs.

Disaster Roaming: This is the special roaming policy that applies during a Disaster Condition.

PLMN with Disaster Condition: A PLMN to which a Disaster Condition applies.

Registered for disaster roaming services: A UE is considered as “registered for disaster roaming services” when it has successfully completed initial registration or mobility registration for disaster roaming services.

Disaster Condition: This is the condition that a government decides when to initiate and terminate, e.g., a natural disaster. When this condition applies, users may have the opportunity to mitigate service interruptions and failures.

Disaster Inbound Roamer: A user that (a) cannot get service from the PLMN it would normally be served by, due to failure of service during a Disaster Condition, and (b) is able to register with other PLMNs.

Disaster Roaming: This is the special roaming policy that applies during a Disaster Condition.

PLMN with Disaster Condition: A PLMN to which a Disaster Condition applies.

Registered for disaster roaming services: A UE is considered as “registered for disaster roaming services” when it has successfully completed initial registration or mobility registration for disaster roaming services.

The purpose of MINT is to minimize interruption of service to the users when the network to which these users are subscribed cannot provide service due to a disaster, by enabling the users to obtain service on other networks, while at the same time protecting those other networks from congestion.

In the description, PLMN D or PLMN-D is subject to disaster (i.e., PLMN-D is the PLMN with disaster condition) and PLMN A or PLMN-A is alive and not subject to disaster. PLMN-A may provide disaster roaming service to the users of the PLMN-D (i.e., to the Disaster Inbound roamers of the PLMN-D). The terms PLMN D and PLMN-D are used interchangeably in this embodiment and have the same meaning. The terms PLMN A and PLMN-A are used interchangeably in this embodiment and have the same meaning.

The terms disaster based service, disaster roaming service and disaster inbound roaming are used interchangeably in this embodiment and have the same meaning.

The terms disaster situation and disaster condition are used interchangeably in this embodiment and have the same meaning.

The terms UE and MS are used interchangeably in this embodiment and have the same meaning.

The term or method where “UE is registering for the disaster roaming service” or “UE is registered for the disaster roaming service” may refer to a situation or condition, but not restricted or limited to, where UE sets or indicates the Fifth Generation System (5GS) Registration type IE to at least one of a “disaster roaming initial registration” and a “disaster roaming mobility registration updating” in the REGISTRATION REQUEST message.

The term area/location/geographical area are used in this embodiment may refer to any of cell/cell ID, Tracking Area Code (TAC)/Tracking Area Identity (TAI), PLMN, MCC/MNC, Latitude/longitude, CAG cell or any geographical location/coordinate.

The solutions explained in this embodiment are applicable to any (but not limited to) of the RAT(s) as defined in this embodiment.

The Network used in this embodiment could be any 5G/EUTRAN Core Network Entities like AMF/SMF/MME/UPF or the Network could be any (but not limited to) 5G/EUTRAN RAN Entity like eNodeB (eNB) or gNodeB (gNB) or NG-RAN etc. The Network used in this embodiment is explained using any 5G Core Network Function for e.g., AMF. However, the network could be any 5G/EUTRAN Core Network Entities (like AMF/SMF/MME/UPF), or the Network could be any 5G/EUTRAN RAN Entity like eNodeB (eNB) or gNodeB (gNB) or NG-RAN etc.

An example list of NAS messages are (but are not limited to) REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT; UE CONFIGURATION UPDATE command, UE PARAMETERS UPDATE command, and so on.

The term Radio Access Technology (RAT) as defined herein can be one of the following: NG-RAN, 5G, 4G, 3G, 2G, EPS, 5GS, NR, NR in unlicensed bands, NR (LEO) satellite access, NR (MEO) satellite access, NR (GEO) satellite access, NR (OTHERSAT) satellite access, NR RedCap, E-UTRA, E-UTRA in unlicensed bands, NB-IoT, WB-IoT, LTE-M, and so on. The solutions which are defined for NR (5GC) can be also applicable to legacy RATs like E-UTRA/LTE, the corresponding CN entities needs to be replaced by LTE entities; for e.g., AMF with MME, g-nodeB with e-nodeB, UDM with HSS etc. But principles of the solution remains same.

PLMN selection as per 23.122 without RPLMN:

The MS selects and attempts registration on any PLMN/access technology combinations, if available and allowable, in the following order:
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality.

PLMN selection as per 23.122 with RPLMN:

The MS selects and attempts registration on any PLMN/access technology combinations, if available and allowable, in the following order:
either the RPLMN or the Last registered PLMN;
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality.

The messages used or indicated in this embodiment are shown as an example. The messages could be any signalling messages between UE and the Network Functions/Entities or between different Network functions/entities.

The methods, issues or solutions disclosed in this embodiment are explained using NR access or NG-RAN Access Technology as an example and is not restricted or limited to NR access only. However, the solutions proposed in this embodiment are also applicable for E-UTRAN access Technology, NB (Narrow Band)-S1 mode or WB (Wide Band)-S1 mode via E-UTRAN access and/or NB-IOT (NarrowBand Internet Of Things) or WB-IOT (WideBand Internet Of Things) Access/Architecture

The term Higher Priority PLMN Search is also commonly called as background PLMN search, “the UE shall periodically attempt to obtain service on its higher priority PLMN/access technology”.

The terms Higher Priority PLMN Search and Higher Priority PLMN Selection are used interchangeably herein and have the same meaning.

The terms Manual Mode and Manual Network Selection Mode are used interchangeably in this embodiment and have the same meaning.

The terms Automatic Mode and Automatic Network Selection Mode are used interchangeably in this embodiment and have the same meaning.

The issues and solutions disclosed herein are explained with disaster roaming services as an example. The issues and solutions proposed in this embodiment are also applicable to the UE and the Network, when the UE is not registered for disaster roaming services (i.e., registered for normal services or normal roaming services).

FIG. 5 illustrates a network comprising at least one UE connected to at least one PLMN. The network 500, as depicted, comprises at least one UE 501, and a plurality of PLMNs 502. Here, considering the UE 501, one of the PLMNs 502 can be a forbidden PLMN (FPLMN) or a Visited PLMN (VPLMN) 502A, wherein in a disaster situation, the UE 501 is registered with the VPLMN 502A. Considering the UE 501, at least one of the other PLMNs 502B can be an allowable PLMN (i.e., a non-forbidden PLMN) 502B, wherein the UE 501 can avail normal service(s) from the allowable PLMN 502B. The allowable PLMN 502B can be an allowable PLMN, or a higher Priority PLMN/access technology.

Consider a scenario, wherein the UE 501 is registered for disaster roaming services with the VPLMN 502A, in a disaster scenario. The UE 501 can be in an automatic mode (or an Automatic Network Selection mode) or a manual mode (or a Manual Network Selection Mode). The UE 501 can periodically attempt to obtain service on an allowable PLMN 502B, in accordance with the requirements as defined in the Automatic Network Selection Mode in clause 4.4.3.1.1 of 3GPP TS 23.122. The UE 501 can make a first attempt to obtain service on the allowable PLMN 502B, after a period of at least T1 duration and at most a T duration upon selecting the VPLMN 502A for disaster roaming.

In an embodiment herein, T1 can be a value less than or equal to a maximum of T period. In an embodiment, T1 can be independent of the value of the timer T. The T1 period of T1 can be pre-configured and stored in the UE. The T1 duration can be stored in the SIM or the USIM of the UE. The T1 period of T1 can be configured in any of the IE/Indication by the network via a NAS/AS signalling message. In an example herein, the T1 duration can be 2 minutes.

In an embodiment herein, the T duration can be a value in a range of 30 minutes to 40 hours, both inclusive, in 30 minutes steps. After the T duration, the UE 501 can make subsequent periodic attempts for scanning for an allowable PLMN 502B. In an example herein, the T duration can have a default value of 60 minutes, if no value for T is stored in the UE 501 and/or a Subscriber Identity Module (SIM) present in the UE 501. For example, if T is configured as 60 mins, T1 can be configured as any value between 0 to 60 mins.

In an embodiment, if the UE 501 is configured with the T duration, the UE 501 shall use a value for T1 that is less than the T duration. If the value configured in the UE 501, or the default value for T1 is more than T, then T1 shall be set to T. The UE 501 does not stop timer T1, when a power saving mode (PSM) or a mobile initiated connection only mode (MICO) or unavailability period or DRX/eDRX has been activated.

The UE 501 can periodically attempt to obtain service on an allowable PLMN 502B, while in idle mode or 5GMM-CONNECTED mode with RRC inactive indication.

The UE 501 can postpone attempting to obtain service on an allowable PLMN 502B:
while the UE 501 is in power saving mode (PSM);
while the UE 501 is receiving eMBMS transport service in idle mode;
till the next eDRX occasion while the UE 501 is configured with eDRX;
while the UE 501 is in relaxed monitoring;
while the UE 501 is in Mobile Initiated Connection Only mode (MICO); or
while the unavailability period is activated in the UE 501.

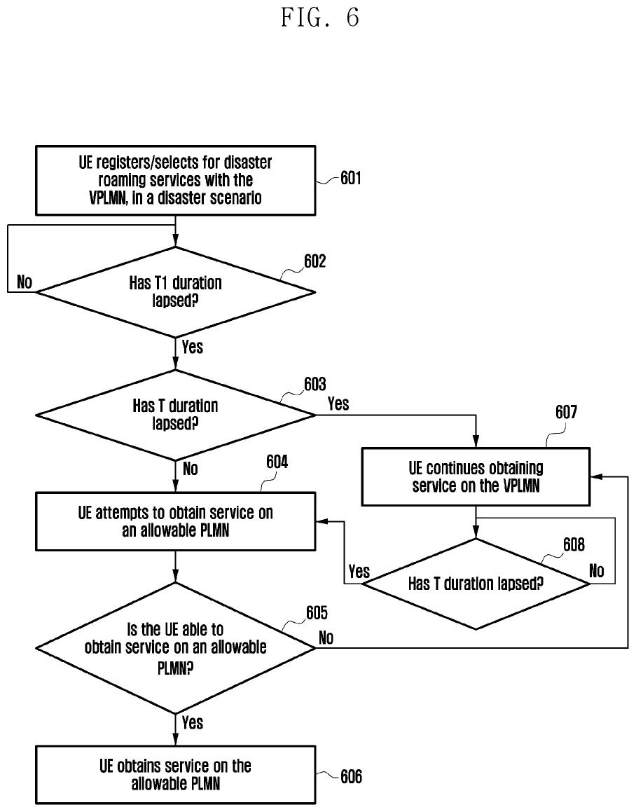

FIG. 6 illustrates a flowchart depicting the process of a UE attempting to select an allowable PLMN, when connected to a VPLMN. In step 601, the UE 501 registers for disaster roaming services with the VPLMN 502A, in a disaster scenario. In step 602, the UE 501 checks if at least the T1 duration has lapsed. T1 can be a value less than or equal to a maximum of T period. In an example herein, the T1 duration can be 2 minutes. If at least the T1 duration has lapsed, in step 603, the UE 501 checks if the T duration has not lapsed. The T duration can be a value in a range of 30 minutes to 40 hours, both inclusive, in 30 minutes steps. In an example herein, the T duration can have a default value of 60 minutes, if no value for T is stored in the UE 501 and/or the SIM present in the UE 501. If the T duration has not lapsed, in step 604, the UE 501 makes the first attempt to obtain service on an allowable PLMN 502B. If the UE 501 is able to obtain service on an allowable PLMN 502B (step 605), in step 606, the UE 501 can obtain service on the allowable PLMN 502B. If the UE 501 is unable to obtain service on an allowable PLMN 502B (step 605) within the T duration, in step 607, the UE 501 continues obtaining service on the VPLMN 502A. In step 608, the UE 501 checks if at least the T duration has lapsed. If the T duration has not lapsed, in step 604, the UE 501 makes the following attempts if the UE 501 is registered for disaster roaming services at time T after the last attempt to obtain service on an allowable PLMN 502B. The various actions in method 600 may be performed in the order presented, in a different order or simultaneously. Further, in some embodiments, some actions listed in FIG. 6 may be omitted.

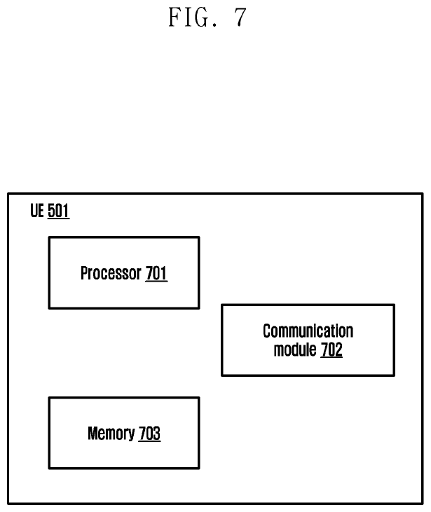

FIG. 7 illustrates various hardware components of the UE 501, according to the embodiments as disclosed herein. In an embodiment, the UE 501 includes a processor 701, a communication module 702, and a memory 703. The processor 701 can be coupled with the communication module 702, and the memory 702.

The processor 701 can be configured to execute instructions stored in the memory 703 and to perform various processes. The communication module 702 configured for communicating internally between internal hardware components and with external devices via one or more networks. The memory 703 can also store instructions to be executed by the processor 701. The memory 703 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 703 may, in some examples, be considered a non-transitory storage medium. The term “non-transitory” may indicate that the storage medium is not embodied in a carrier wave or a propagated signal. However, the term “non-transitory” should not be interpreted that the memory 703 is non-movable. In certain examples, a non-transitory storage medium may store data that can, over time, change (e.g., in Random Access Memory (RAM) or cache).

The processor 701 can receive the T1 duration from a network, via the communication module 702. The processor 701 can receive the T1 duration in a NAS/AS signalling message. The processor 701 can store the received T1 duration in the memory 703.

The processor 701 can receive the T duration from a network, via the communication module 702. The processor 701 can store the received T duration in the memory 703.

Consider a scenario, wherein the UE 501 is registered for disaster roaming services with the VPLMN 502A, in a disaster scenario. The UE 501 can be in an automatic mode (or Automatic Network Selection mode) or a manual mode (or Manual Network Selection mode). The processor 501 can periodically attempt to obtain service on an allowable PLMN 502B. The UE 501 can make the first attempt to obtain service on the allowable PLMN 502B, after a period of at least T1 duration and at most the T duration upon selecting a VPLMN for disaster roaming. In an embodiment herein, T1 can be a value less than or equal to the maximum of T period. In an example herein, the T1 duration can be 2 minutes. In an embodiment herein, the T duration can be a value in a range of 30 minutes to 40 hours, both inclusive, in 30 minutes steps. In an example herein, the T duration can have a default value of 60 minutes, if no value for T is stored in the memory 503 and/or the SIM present in the UE 501.

Although the FIG. 7 shows various hardware components of the UE 501, but it is to be understood that other embodiments are not limited thereon. In other embodiments, the UE 501 may include less or a greater number of components. Further, the labels or names of the components are used only for illustrative purpose and does not limit the scope of the disclosure. One or more components can be combined together to perform same or substantially similar function in the UE 501.

In an embodiment herein, the allowable PLMN shall or shall not belong to the same country as the current serving PLMN. In yet another embodiment, the allowable PLMN shall be of the same country as the current serving PLMN. In yet another embodiment, the allowable PLMN can be of a different country as the current serving PLMN.

In an embodiment, if the UE 501 is configured with the MinimumPeriodicSearchTimer, the UE shall not use a value for T that is less than the MinimumPeriodicSearchTimer. If the value stored in the SIM, or the default value for T (when no value is stored in the SIM), is less than the MinimumPeriodicSearchTimer, then T shall be set to the MinimumPeriodicSearchTimer.

In an embodiment, the UE 501 does not stop timer T when it activates power saving mode (PSM) or mobile initiated connection only mode (MICO).

In an embodiment, The periodic attempts to obtain service on an allowable/Higher Priority PLMN/access technology shall only be performed when the UE is registered for disaster roaming services and does not have a PDU session for emergency services. The periodic attempts shall be performed in both Automatic and Manual Mode when the MS is registered for disaster roaming services and does not have a PDU session for emergency services. In yet another embodiment, the periodic attempts shall only be performed in automatic mode when the MS is registered for disaster roaming services and does not have a PDU session for emergency services;

In an embodiment herein, the UE 501 shall make the first attempt after a period of at least 2 minutes and at most the time configured for T upon selecting a VPLMN for disaster roaming. In yet another embodiment, the UE 501 shall make the first attempt after a period of at least T1 duration and at most T duration:
only after switch on if Fast First Higher Priority PLMN search is disabled; or
after switch on or upon selecting and/or registering on a VPLMN/any PLMN/access technology for disaster roaming service if Fast First Higher Priority PLMN search is enabled; or
after switch on or upon selecting and/or registering on a VPLMN/any PLMN/access technology for disaster roaming service if Fast First Higher Priority PLMN search is enabled, in accordance with the requirements as defined in the Automatic Network Selection Mode in clause 4.4.3.1.1 of 3GPP TS 23.122; or
after switch on or upon selecting and/or registering on a VPLMN/any PLMN/access technology for disaster roaming service. Irrespective of whether Fast First Higher Priority PLMN search feature exists in the UE, the UE 501 may/may not use the UE's status (enabled/disabled) to perform Higher priority PLMN search when registered for disaster roaming service.

In an embodiment herein, the Timer T1 is any timer less than or equal to Timer T. For example, if T is configured as 60 minutes, T1 can be configured as any value between 0 to 60 minutes, for example, 2 minutes. It may also indicate that no periodic attempts shall be made. If no value for T1 is stored in the SIM, a default value of 60 minutes is used for T1. If the MS is configured with the MinimumPeriodicSearchTimer, the MS shall not use a value for T1 that is less than the MinimumPeriodicSearchTimer. If the value stored in the SIM, or the default value for T1 (when no value is stored in the SIM), is less than the MinimumPeriodicSearchTimer, then T1 shall be set to the MinimumPeriodicSearchTimer. The MS does not stop timer T1, when it activates power saving mode (PSM) or mobile initiated connection only mode (MICO).

In an embodiment herein, the Timer T1 can be a timer, independent of Timer T, and the value is in the range 30 minutes to 40 hours. In yet another embodiment, the Timer T1 can be a timer in the range of 0 minutes to 60 mins (for example, 2 minutes).

In an embodiment herein, the Timer T1 can be pre-configured in the UE (ME or USIM) or can be configured by the Network in any NAS/AS signalling message.

In an embodiment herein, the Timer T1 can be any value based on UE implementation manner.

In an embodiment herein, the UE 501 shall make the following attempts if the UE is registered for disaster roaming services at time T after the last attempt.

In an embodiment herein, if the allowable PLMN or any higher priority PLMN is not found, the UE 501 shall remain registered on the VPLMN for disaster roaming service.

In an embodiment herein, the UE 501 shall not limit its attempts to access allowable/Higher Priority PLMN/access technology combinations of the same country as the current serving PLMN/VPLMN. The UE 501 shall attempt to access any allowable/Higher Priority PLMN/access technology combinations, irrespective of the country as the current serving PLMN/VPLMN.

In an embodiment herein, the UE 501 shall limit its attempts to access allowable/Higher Priority PLMN/access technology combinations of the same country as the current serving PLMN/VPLMN, as defined.

EXCEPTION: If the UE 501 is in a PLMN/VPLMN for disaster roaming services through satellite NG-RAN access with a shared MCC, the UE 501 may attempt to access allowable/higher priority PLMN/access technology combinations irrespective of their MCC values.

EXCEPTION: If the UE 501 is in a PLMN/VPLMN for disaster roaming services through non-satellite access, the UE 501 may attempt to access higher priority PLMNs with a shared MCC with any NG-RAN access technology.

In an embodiment herein, the UE 501 shall limit its attempts to access allowable/Higher Priority PLMN/access technology combinations of the same country as the current serving PLMN/VPLMN, as defined.

EXCEPTION: If the UE 501 is in a PLMN/VPLMN for disaster roaming services through satellite NG-RAN access with a shared MCC, the UE 501 may attempt to access allowable/higher priority PLMN/access technology combinations irrespective of their MCC values.

EXCEPTION: If the UE 501 is in a PLMN/VPLMN for disaster roaming services through non-satellite access, the UE may attempt to access higher priority PLMNs with a shared MCC with satellite NG-RAN access technology.

Note: While a UE 501 is roaming on a PLMN/VPLMN, the VPLMN and a PLMN are of the same country only if their MCC values identify the same country.

Embodiments disclosed herein are explained with disaster roaming services as an example. The issues and solutions proposed in this embodiment are also applicable to the UE and the Network, when the UE is not registered for disaster roaming services (i.e., registered for normal services or normal roaming services).

The embodiments disclosed herein can be implemented through at least one software program running on at least one hardware device and performing network management functions to control the elements. The elements shown in FIGS. 5 and 7 can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a terminal in a wireless communication system, the method comprising:
selecting a visited public land mobile network (VPLMN) for disaster roaming services; and
making a first attempt to obtain a service on an allowable public land mobile network (PLMN) after a duration of a second timer and at most a duration of a first timer.

2. The method of claim 1,
wherein the selecting the VPLMN for disaster roaming services further comprises:
registering on the VPLMN for disaster roaming services.

3. The method of claim 1,
wherein the duration of the first timer is 30 minutes to 40 hours of time range in 30 minutes steps.

4. The method of claim 1,
wherein a duration of the second timer is at least 2 minutes.

5. The method of claim 1,
wherein the terminal does not stop the first timer in case that it activates a power saving mode (PSM) or a mobile initiated connection only mode (MICO).

6. The method of claim 1,
wherein the first attempt to obtain the service on the allowable PLMN is performed in an automatic mode in case that the terminal is registered for disaster roaming services and does not have a protocol data unit (PDU) session for emergency services.

7. The method of claim 1, further comprises:
in case that the first attempt is failed, identifying the first timer is expired after making the first attempt; and
in case that the first timer is expired, making a following attempt to obtain the service on the allowable PLMN.

8. The method of claim 1,
wherein the first attempt to obtain the service on the allowable PLMN is performed by the terminal in an idle mode or a 5G system mobility management (5GMM) connected mode with a radio resource control (RRC) inactive indication.

9. The method of claim 1,
wherein the first attempt to obtain the service on the allowable PLMN is delayed:
in case that the terminal is in a power saving mode (PSM);
in case that the terminal is receiving evolved a multimedia broadcast multicast service (eMBMS) transport service in an idle mode;
until next extended discontinuous reception (eDRX) occasion in case that the terminal is configured with the eDRX;
in case that the terminal is in relaxed monitoring;
in case that the terminal is in a mobile initiated connection only mode (MICO); or
in case that unavailability period is activated in the terminal.

10. A terminal in a wireless communication system, the terminal comprising:
a transceiver; and
at least one processor coupled with the transceiver and configured to:
select a visited public land mobile network (VPLMN) for disaster roaming services, and
make a first attempt to obtain a service on an allowable public land mobile network (PLMN) after a duration of a second timer and at most a duration of a first timer.

11. The terminal of claim 10, wherein the at least one processor further configured to:
select the VPLMN for disaster roaming services, and
register on the VPLMN for disaster roaming services.

12. The terminal of claim 10,
wherein the duration of the first timer is 30 minutes to 40 hours of time range in 30 minutes steps.

13. The terminal of claim 10,
wherein a duration of the second timer is at least 2 minutes.

14. The terminal of claim 10,
wherein the terminal does not stop the first timer in case that it activates a power saving mode (PSM) or a mobile initiated connection only mode (MICO).

15. The terminal of claim 10,
wherein the first attempt to obtain the service on the allowable PLMN is performed in an automatic mode in case that the terminal is registered for disaster roaming services and does not have a protocol data unit (PDU) session for emergency services.

16. The terminal of claim 10, wherein the at least one processor further configured to:
in case that the first attempt is failed, identify the first timer is expired after making the first attempt, and
in case that the first timer is expired, make a following attempt to obtain the service on the allowable PLMN.

17. The terminal of claim 10,
wherein the first attempt to obtain the service on the allowable PLMN is performed by the terminal in an idle mode or a 5G system mobility management (5GMM) connected mode with a radio resource control (RRC) inactive indication.

18. The terminal of claim 10,
wherein the first attempt to obtain the service on the allowable PLMN is delayed:
in case that the terminal is in a power saving mode (PSM);
in case that the terminal is receiving evolved a multimedia broadcast multicast service (eMBMS) transport service in an idle mode;
until next extended discontinuous reception (eDRX) occasion in case that the terminal is configured with the eDRX;
in case that the terminal is in relaxed monitoring;
in case that the terminal is in a mobile initiated connection only mode (MICO); or
in case that unavailability period is activated in the terminal.
